(19) United States
(12) Patent Application Publication
(10) Pub. No.: US 2009/0259890 A1
(43) Pub. Date: Oct. 15, 2009

(54) Method & apparatus for hardware fault management

(75) Inventors: Mats Lund, Novato, CA (US); Luu Nguyen, Santa Rosa, CA (US); Heidi Pickreign, Harvard, MA (US); Martin Belanger, Petaluma, CA (US); Michael R. Mayhew, Naperville, IL (US); Scott Pradels, Santa Rosa, CA (US)

Correspondence Address: ROBERT SCHULER, 45 GROTON ROAD, SHIRLEY, MA, 01464, US

(73) Assignee: TURIN NETWORKS

(21) Appl. No.: 12/082,715

(22) Filed: Apr. 14, 2008

(51) Int. Cl. G06F 11/22

(52) U.S. Cl. 714/35; 714/E11.148

(57) ABSTRACT

A hardware health evaluation module is associated with a hardware module or device and employs a linked list of error records to continually evaluate the state of the hardware module to determine whether or not it is currently operating with or without errors. In the event that the health evaluation module determines that the hardware module is not operating in an error free manner, it detects and stores, for a specified period of time, an indication of the error and associates this detected error or errors with one or more of the error records. The error records are designed to provide assistance in diagnosing the cause of a hardware error.

### FIELD OF THE INVENTION

The invention relates generally to the area of monitoring faults in electronic device hardware and specifically to using hardware fault records of a particular format in conjunction with a hardware fault management engine to detect hardware faults and to determine the health of the hardware.

### BACKGROUND OF THE INVENTION

Communications network hardware infrastructure is typically composed of a number of different classes of electronic modules or systems that operate to move traffic from one point to another in the network. These modules can be complex hardware devices with a number of large discrete hardware components the operation of which can deteriorate over time resulting in the module's inability to correctly process information arriving at the module over the communications network which will result in faulty hardware operation.

From the perspective of the communications network, faulty network hardware module operation may not always be directly detectible or obviously affect the service the module provides to the network. On the other hand, the faulty operation of a network hardware module can be fatal to the operation of a portion or all of the communication system. At the point that a hardware module ceases to operate in a fault free manner resulting in a fatal error or module crash, it becomes necessary for a system technician to perform some sort of diagnostic procedure on the module. This procedure may be performed with the network module in place or the network module may have to be removed. Regardless of whether or not the network module is removed from the system for the purpose of fault diagnosis, some faults generated by the network device hardware components can be very difficult to diagnose. Consequently, communication network modules are designed to include hardware registers that are employed to store particular types of hardware errors during the operation of the network module in the network. These errors can be bit errors, or CRC errors, out of synchronization errors to name only three. At the point that the network module fails or crashes, these stored hardware errors can be “dumped” either automatically or manually by the service technician and examined as part of the diagnostic process.

Much of the prior art in this area is concerned with determining the cause of hardware failures after the hardware ceases to operate in a fault free manner. U.S. Pat. No. 7,171,593 assigned to the Unisys Corporation describes an apparatus for scanning some or all of the hardware components in a computer system for the purpose of examining the hardware state information. In the event that there is a hardware failure that causes the system to crash, or upon operator command, a system maintenance processor retrieves the state information and sends it to a location in the computer where it can be examined by a technician to determine why the error occurred. U.S. Pat. No. 5,210,862 assigned to Bull HN Information Systems describes a bus monitoring arrangement in which certain bus conditions trigger the bus monitor to record the state of system hardware at the time of the condition. The recorded state of the system can then be examined at some later time by a technician to determine the cause of the bus error. While the prior art methods for detecting and logging hardware errors do facilitate the identification of the cause of hardware faults, this identification process only occurs after the hardware has ceased to operate properly or has “crashed”. The prior art described above only collects hardware error information for examination later by a technician for the purpose of determining the cause of the error. Although the manner in which the hardware error information is collected and stored facilitates the trouble shooting process, these techniques do not result in an indication of the health of the hardware and do not provide an indication of possible future hardware failures.

In certain electronic systems it is advantageous to recognize that a hardware component, although functioning within its specified limits and not affecting the operation of a larger system or network of which it may be a part, is not functioning without errors. Typically large electronic systems or communication networks are designed to process information that contains a limited number of errors. At the point that the information being processed includes more than a specified number of errors, the information can then become less useful and the end user of the information may notice a marked drop in the quality of the information. So, for instance, if a hardware component in a communications network responsible for processing data or voice information injects errors into this information that exceeds some specified quantitative limit, then the quality of this information can be compromised and at some point becomes less useful (quality or fidelity of voice traffic deteriorates) to an end user. U.S. Pat. No. 5,469,463 assigned to Digital Equipment Corporation describes a system for detecting and logging errors in hardware components, such as various types of disk drives, and then employing an expert software system to analyze the logged errors to determine their cause. Further, this system is capable of identifying and predicting “likely failure points” in the hardware. Designing and implementing expert software systems to analyze the cause of such detected hardware errors is a complicated and time consuming task, but such expert systems are useful in as much as a less experienced and very often lower paid technician can effectively resolve difficult to diagnose hardware problems.

### SUMMARY OF THE INVENTION

The invention provides a new and improved method and apparatus for detecting hardware errors and for determining the health of a hardware device so that it is possible to provide notification of possible future hardware failures prior to the hardware affecting the quality of the service it provides to a system or to a network. Furthermore, an expert software system is not needed to practice the method of the invention. One or more fault records comprised of a plurality of pre-selected fault keys is employed by the invention to selectively monitor the hardware device registers for current state information. The fault records can be modified and integrated into the inventive fault detection method while the hardware is operational. The invention permits the health of selected hardware functions to be monitored in real-time with warnings or alarms issued to a GUI in the event that it is determined that there is a possibility that the hardware can fail in the future. Further, the method of the invention allows for the automatic re-initialization of the hardware depending upon the fault keys included in any particular fault record. Still further, the method and apparatus of the invention is designed to be easily portable across different hardware devices.

In one embodiment, the evaluation of the health of a hardware device includes the creation of one or more fault records each of which includes a set of fault keys, a hardware fault detection function that uses the set of fault keys associated with at least one of the fault records to detect error information in a hardware register associated with the hardware device, storing the detected error information associated with the at least one fault record in a storage device associated with the hardware device; and employing a hardware device health function to compare the stored error information with the associated fault record to evaluate the health of the hardware device.

In another embodiment, the evaluated health of the hardware device is used to generate a message for display in a GUI that indicates the health of the hardware device.

### BRIEF DESCRIPTION OF THE FIGURES

FIG. 1 is a functional block diagram illustrating a representative hardware device.

FIG. 2 is a functional block diagram illustrating the elements necessary for the operation of the invention.

FIG. 3 is an example of the format of a hardware error record.

FIG. 4A is an example of the format of an HFM record.

FIG. 4B is an example of the format of a linked list of HFM records.

FIG. 5 is a block diagram of an HFM Engine of the invention and peripheral functionality.

FIG. 6 is a high level logical flow diagram of the process of the invention.

FIG. 7A is a detailed logical flow diagram of step 3 or step t of the logical flow diagram of FIG. 6.

FIG. 7B is a continuation of the logical flow diagram of FIG. 7A.

### DETAILED DESCRIPTION OF THE INVENTION

Although the preferred embodiment of the invention is described in the context of a communications network, the invention can also be implemented in a hardware module or system that is not connected to a communications or another other type of network. Hardware failures can be difficult to diagnose as the cause of such failures may be associated with a hardware component or device other than the device that actually captures or records the failure information. Some hardware failures are intermittent in nature and occur infrequently and other hardware failures are intermittent in nature but occur frequently and so it is important to record this type of error over some specified period of time in order to provide sufficient failure information to perform an effective diagnostic process. Regardless of the type of hardware failures, in order to determine the current health of a hardware module and to predict that the hardware module is at risk of failure at some point in future (i.e. future health), it is necessary to capture and store the state of the hardware over time so that it can be periodically examined to determine the health of the module and serve as a starting point for a diagnostic process. For the purpose of this description, hardware failures can be the result of low level errors associated with the hardware operation. These lower level errors can be detected by hardware mechanisms and stored in a hardware register, associated with the hardware module or discrete device, which is predetermined to be useful in diagnosing hardware faults.

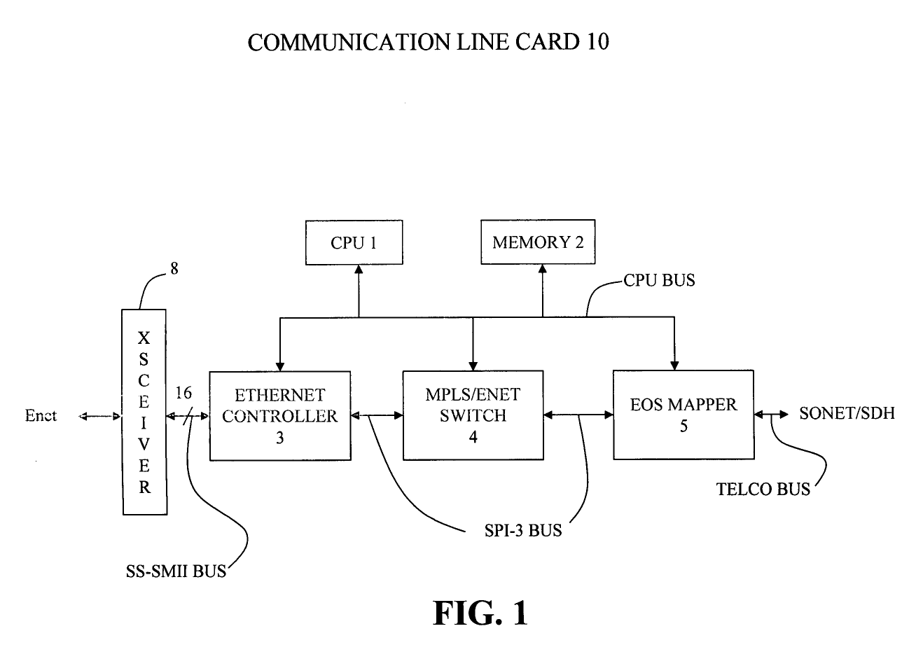

The method and apparatus of the invention can be implemented on many different hardware module or device designs. For the purpose of this description, the invention will be described in the context of a communication line card. FIG. 1 is a functional block diagram of a communication line card 10 that in this case implements network interface functionality between an Ethernet network and an SONET/SDH network. A central processing unit (CPU) 1 and associated memory 2, which can a non-volatile memory device, generally operate to provide signal conditioning functionality for an Ethernet Controller 3, an MPLS/Ethernet switch 4 and the Ethernet over Sonet (EOS) mapper 5. Specifically, as will be describe in detail later, the CPU 1 and memory 2 operate together to perform the novel hardware health evaluation functionality of the invention. A transceiver 8 generally acts as the interface between the line card 10 and the network 6 physical layer and specifically it operates to transmit packets of information to and receive packets of information from the network 6 that operates according to one or more of the well known set of IEEE 802.3 Ethernet protocols. The transceiver 8 communicates with the Ethernet controller 3 over one or more Source Synchronous Serial Media Independent Interface (SS-SMII) bus and provides all medium access control to the network and it provides rate adaptation (buffering) for packets of information sent to it by the transceiver 8. The Ethernet controller 3 is in communication with the switch 4 over an SPI-3 bus as shown in FIG. 1. The switch 4 performs an MPLS/Ethernet switching function which switches one or more Ethernet physical ports to a plurality of virtual EoS ports and conversely switches the plurality of virtual EoS ports to the one or more Ethernet ports. The EoS device 5 is an Ethernet-over-Sonet mapper that provides 128 virtual concatenation groups (VCS) and support variable rate voice traffic. The EoS device 5 receives packets in an Ethernet/MPLS format and maps the information contained in the packets to STS signals that are transmitted to the network 7 which support SONET/SDH. The Ethernet controller 3, the MPLS/Ethernet switch 4 and the EoS mapping device 5 all provide functionality that is well understood by network communications engineers and is not central to the implementation of this invention and so will not be described here in any greater detail. Although the invention is described here in the context of the network communication line card 10, the invention is easily implemented on any type of network communications module or any hardware system not necessarily connected to a network and is not limited to the network card 10 described above.

Continuing to refer to FIG. 1, each of the hardware devices described in the preceding paragraph that are included on the line card 10 can include addressable hardware registers that capture at least some of the operational state of each device. One or more of these hardware registers on each device can be dedicated to capturing error information associated with the device. So for instance, the Ethernet controller 3 includes a register dedicated to capturing hardware error information resulting from the MPLS/Ethernet switch 4 trying to send a packet larger than a particular specified number of bytes, which in this case is 9216 bytes including CRC. Specifically, the Ethernet controller 3 includes a register “G_DIAG_CNTRS” that is dedicated to capturing packet length errors in packets transmitted from the MPLS/Ethernet switch 4 to the Ethernet controller 3. As the result of an oversized packet being received by the Ethernet controller 3, particular bits in the “G_DIAG_CNTRS” register are set and these bits are examined by a software or firmware routine which returns, in this case, a plurality of values that indicate the operational state of the Ethernet controller 3. In the preferred embodiment of the invention, a polling API is called by a hardware health evaluation module that examines and then returns one of three possible values from the “G_DIAG_CNTRS” register. These three values can be “0”, “1” and “3” which serve to indicate that there is no fault, a non service-affecting fault or a service-affecting fault respectively. The polling API can be a function which includes instructions to examine and return error information contained in specific hardware registers, such as in the “G-DIAG_CNTRS” register for instance.

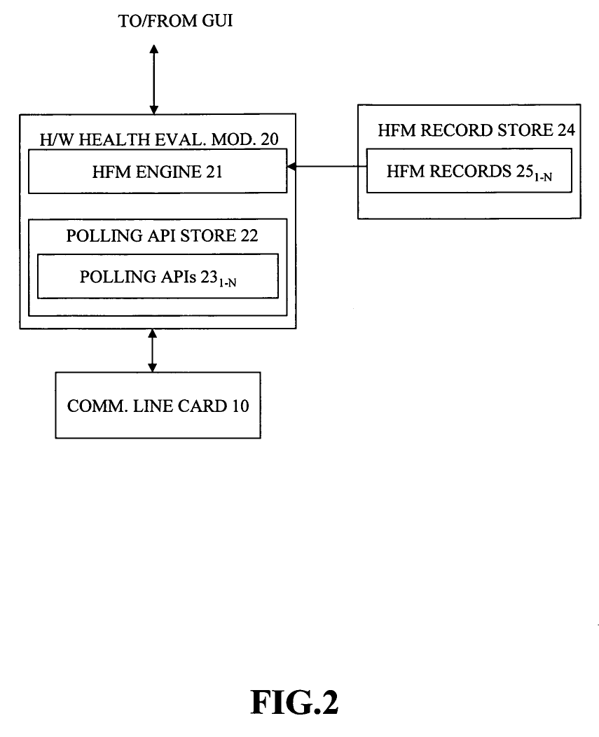

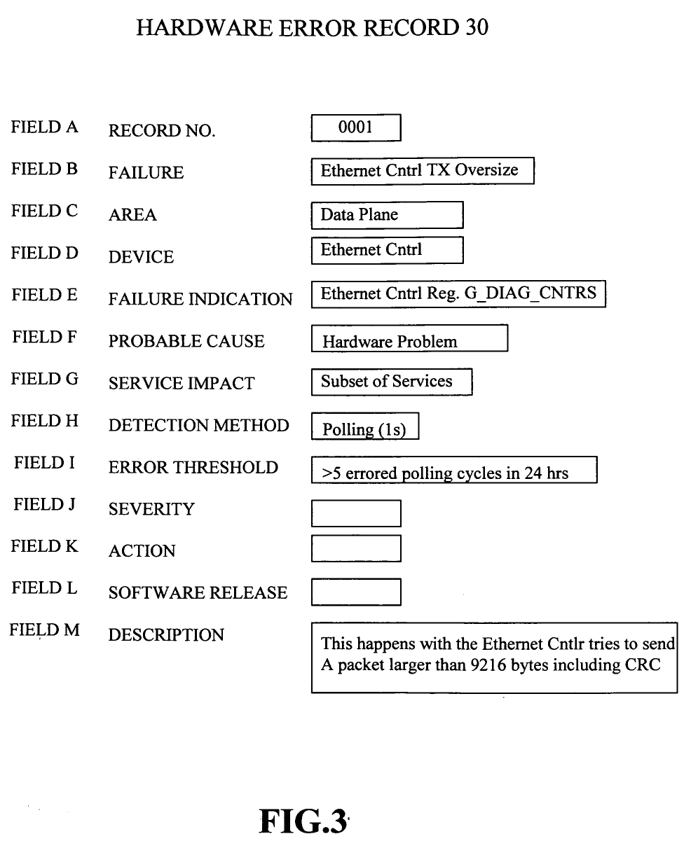

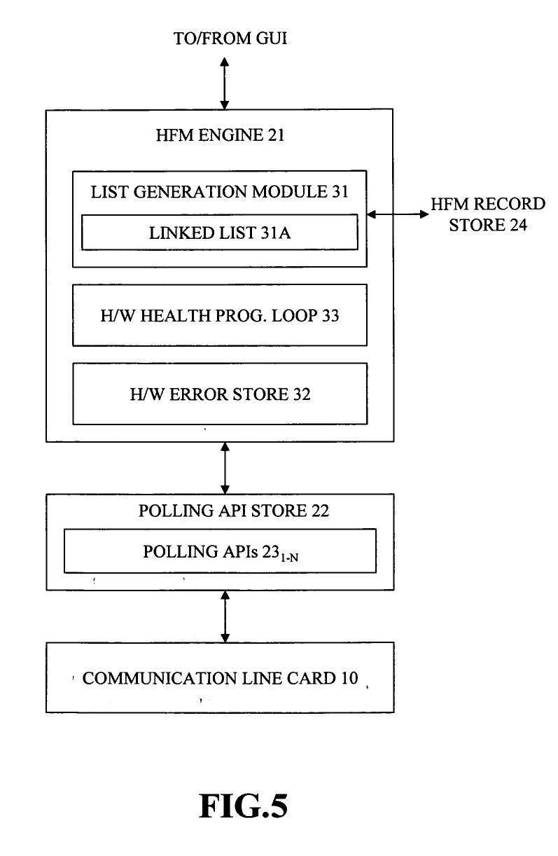

FIG. 2 is a block diagram showing the functional elements included in a hardware module, such as the line card 10 of FIG. 1, that are necessary to perform the hardware health evaluation functionality of the invention. A hardware health evaluation module 20, hereinafter referred to as the evaluation module 20 which can reside in memory 2 of FIG. 1, generally operates to periodically examine the contents of a hardware register, such as the “G_DIAG_CNTRS” register described previously with reference to FIG. 1, to determine whether or not and what kind of error information is stored in the register. The evaluation module 20 can store this error information for a specified period of time and periodically evaluate this stored error information for the purpose of creating hardware module health alarm message that an engineer can use to diagnose the cause of a hardware fault, or which the hardware module can use to perform some automatic corrective operation, such as re-initializing the module. Specifically, the evaluation module 20 includes a hardware fault management engine (HFM engine) 21 and one or more polling API's 23_{1-N}. Upon boot up of the line card 10, the HFM engine 21 automatically loads a plurality of HFM records 25_{1-N}, referred to herein generally as hardware fault records, stored in HFM record store 24 located in memory 2 of FIG. 1, and links this plurality of HFM records together to create a linked list of HFM records. The HFM engine 21 operates on this linked list of HFM records to periodically examine the contents of hardware registers associated with a hardware module 10 to determine whether or not hardware error information is present in the register. If error information is present in the register, the HFM engine 21 evaluates whether the error is service affecting or non service affecting and stores this information in memory 2 as an error value. As mentioned above, the evaluation module 20 also includes a store 22 of one or more polling API's 23_{1-N} which are functions that the HFM engine 21 executes to examine the hardware register contents and which functions return the error value described above. In operation, the HFM engine 21 performs a continuous program loop through the linked list of HFM records, examining one or more hardware registers according to a frequency that is specified in each of the HFM records included in the linked list. A more detailed description of the format of an HFM record employed in the preferred embodiment of the invention and HFM engine 21 will be described later in more detail with reference to FIGS. 3 and 5 respectively. Finally, any alarms generated by the HFM engine 21 as the result of evaluating error information stored in hardware error registers can be sent to a graphical user interface (GUI) 26 to be observed by an engineer for use in the diagnostic process or can be employed by the HFM engine 21 to perform some automatic corrective operation. An alarm is typically generated in the event that a hardware module is no longer operating correctly or has crashed to indicate that a hardware module may fail at some point in the future. Although the preferred embodiment of the evaluation module 20 is implemented in software, it can also be implemented in firmware or on a removable medium or any other suitable storage medium.

The HFM records 25_{1-N} described previously with reference to FIG. 2 are created, either automatically or manually by network hardware or software engineer, based on information included in a hardware error record 30 the format of which will now be described with reference to FIG. 3. The preferred embodiment of hardware error record 30 includes thirteen fields of information some or all of which can be used to generate an HFM record. The information included in each of these thirteen fields is specified based on failure information gathered from hardware registers on failed modules and diagnostic knowledge gained by engineers over time with respect to hardware failures that manifest themselves on particular hardware modules such as the line card 10. Field “A” in the hardware error record 30 includes a unique record number, such as “00001” or “00005”. Field “B” is a general description of the failure which includes the hardware device that experienced the failure, the “Ethernet controller 3” in this case, the failure type which in this case is one or more “TX Oversize” errors and a failure category, “(C3)”, which indicates that a SW bug or configuration error is likely. Field “C” includes information indicating in which area of the hardware module the error was detected. In the preferred embodiment of the invention, three areas can be listed in field “C”; namely, an infrastructure area which includes such elements as the module chassis and power supplies, a control plane area which includes such elements as a CPU, control memories, or CPU busses and a data plane which includes such elements as SONET/SDH framers, packet processing chips or data buses. Field “D” includes the name of a device in which the hardware register that stores the error information resides which in this case is the Ethernet controller 3 of FIG. 1. Field “E” includes specific information regarding which register in the Ethernet controller 3 which stores error information and information about which bits are set in this register. Field “F” provides an indication as to the probably cause of the failure which in this case can be a SPI-3 bus problem or a soldering issue. Field “G” includes an indication of the line card 10 services that are impacted by the error which in this case are all of the services. Field “H” specifies what method the HFM engine 21 uses to detect a failure and in this case the detection method indicates that the “G_DIAG_CNTRS” register located on the Ethernet controller 3 should be “polled” at approximately one second intervals. Field “I” specifies an error threshold of greater than five errored polling cycles in twenty four hours. This means that the error threshold is exceeded if during a twenty four hour period the HFM engine 21 polls a hardware register and detects hardware error information in a register for six of these polling instances. Field “J” includes a number, 1-4, which provides an indication of the severity of the failure. A “1” is an indication of a critical failure or that a service affection condition has occurred and immediate corrective action is required. A “2” is an indication that a major failure has occurred or that a service affection condition has occurred and urgent corrective action is required. A “3” is an indication of a minor failure has occurred that is a non-service affecting condition and that corrective action should be taken to prevent a more serious fault, and “4” is a warning that a hardware failure that can potentially affect service may be imminent. Field “K” specifies what action can be taken to correct the failure. Such corrective action can be the automatic resetting or rebooting of the hardware module, for instance. Field “L” includes software release information and Field “M” includes information that can be used by a engineers to assist with the diagnosis of a hardware module failure. Although thirteen fields are specified in the preferred embodiment, more or fewer fields can be specified.

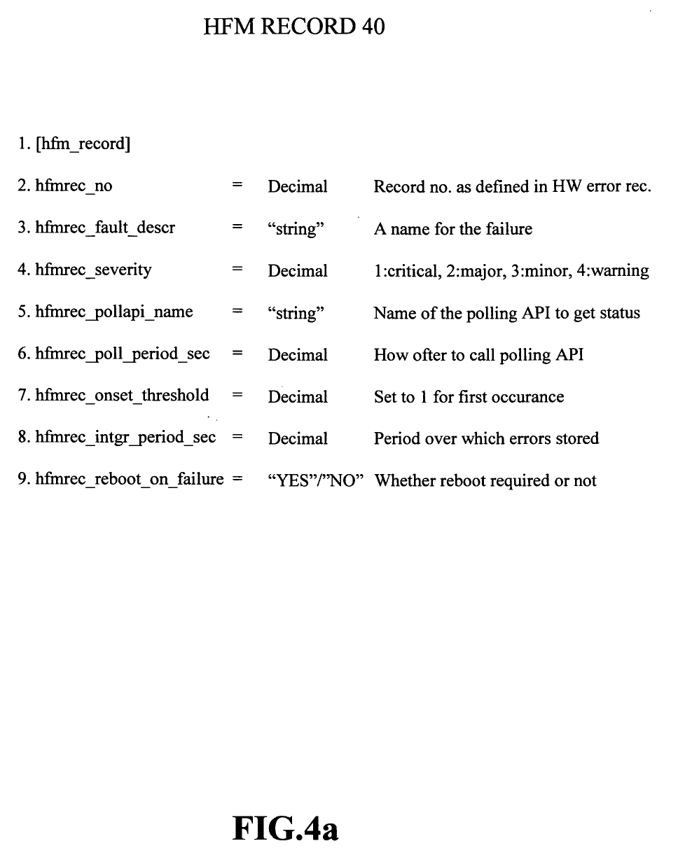

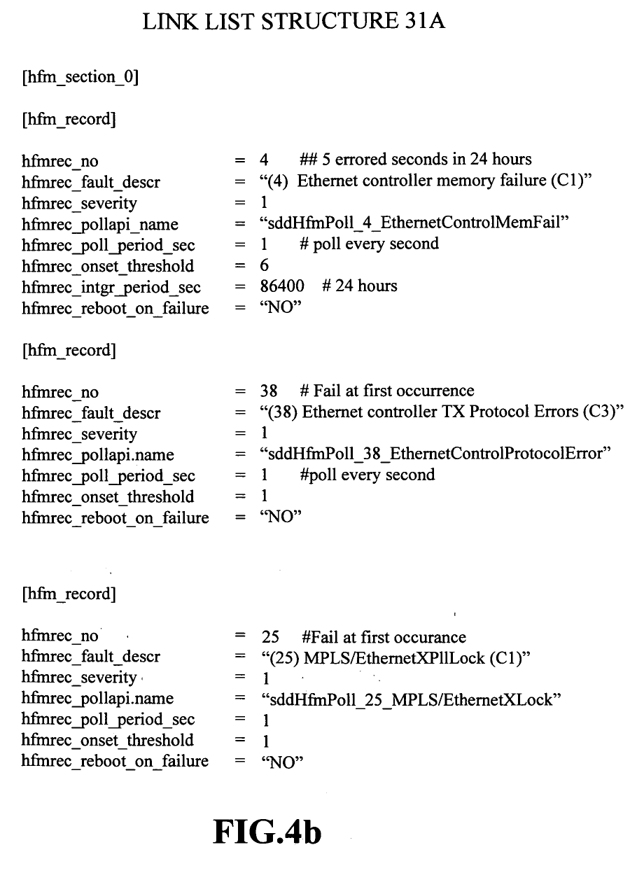

As previously described, the HFM records 25_{1-N} are either automatically or manually generated by an engineer and stored in memory 2 of FIG. 1. An engineer, for instance, can use some or all of the information contained in the hardware error record 30 fields A-M to generate a HFM record. Referring now to FIG. 4a, the general format for an HFM record 40 is shown. Each line of code in the HFM record 40 is comprised of a “key” or “name-value pair” which equates to information included in a particular field of a hardware error record 30. Generally, the first line of code in each HFM record starts with the declaration “[hfm_record]” which indicates that the proceeding plurality of lines of code represent a single HFM record 40. The second line of code in the HFM record is a unique decimal number that corresponds to field “A” of a hardware error record. The third line of code includes a name for the failure. This name corresponds to the information included in field “B” of a hardware error record 30. The forth line of code is an indication of the severity of the failure and corresponds to information included in field “J” of a hardware error record 30. The fifth line of the code specifies the name of a polling API 22 of FIG. 2 employed by the HFM engine 21 to examine and return hardware register error information or status. The sixth line of the code specifies the frequency with which the HFM engine 21 calls the polling API specified in line five. The seventh line of the code specifies a threshold that corresponds to the error threshold specified in field “I” of a hardware error record. The eighth line of the code specifies the “integration period” or period of time over which separate instances of error information are gathered from the hardware register, which in this case is “G_DIAG_CNTRS” register located on the Ethernet controller 3 of FIG. 1, will be stored before it is discarded. In the preferred embodiment, a “leaky bucket” algorithm is used to discard stored error information. Finally, the ninth line of the code specifies what action can be taken when the error threshold, described with reference to Field I in FIG. 41a, is exceeded.

Many customers do not want to reboot or restart their hardware during operation as such actions will interrupt traffic on a communications network. Therefore, it is advantageous for the HFM engine 21 of FIG. 2 to be able to read modified HFM records without interrupting the normal operation of a hardware module. Any of the fields in a hardware fault record, such as the record 30 of FIG. 3, can be modified by an engineer at any time based on diagnostic information gathered during the operation of a hardware module. An engineer can utilize this modified fault record information to update one or more of the key value pairs contained in a HFM record. Periodically, the HFM engine 21 of FIG. 2 can read the contents of each HFM record to update a linked list of HFM records while the hardware module is operational.

FIG. 4b illustrates the structure of a linked list of HFM records previously mentioned with reference to FIG. 1. Each HFM record 25_{1-N} is created for detecting particular hardware faults on the line card 10. Each linked list is defined by including the declaration “[hfm_section_n]” at the start of the list. This declaration is then followed by another declaration, “[hfm_record]” that the following lines of code, which are a plurality of “key value pairs”, represent a particular HFM record number. Each individual HFM record is linked to the next in the list by simply including another HFM record declaration at the end of the number of sequential “key value pairs” associated with the previous HFM record. FIG. 4b illustrates a linked list that incorporates three separate HFM records which for the purpose of this description are HFM records “4”, “38” and “25” although the records can be any three of the HFM records 25_{1-N} that are generated specifically for the line card 10.

FIG. 5 is a block diagram showing the functional elements or modules employed to implement the preferred embodiment of the HFM engine 21 of FIG. 2 that can reside in memory 2 of FIG. 1. The HFM engine 21 generally operates on a linked list of HFM records to examine particular hardware registers for error information and to store an indication that and error or errors have occurred the particular hardware register that is examined. This stored error information is then employed by the HFM engine 21 to evaluate the health of a hardware module. More specifically, the HFM engine 21 is comprised of a list generation module 31 and associated linked list 31a of HFM records 25_{1-N}, a hardware error store 32 and a hardware health program loop 33. The list generation module 31, upon boot up of the communications line card 10 of FIG. 1, automatically fetches a plurality of the HFM records 25_{1-N}, located in the HFM record store 24, that are specifically created to diagnose hardware problems associated with line card 10 and then proceeds to create a linked list of HFM records 31A with the HFM records read from the store 24 as described previously with reference to FIG. 4b. The hardware health program loop 33 operates to continuously loop through the linked list 31A of FIG. 4b to execute the code included in each HFM record included in the list. Specifically, the program loop 33 examines each line of code in the linked list of HFM records 31A and executes this code according to the instructions in each line or argument. As the result of executing the instructions contained in the linked list of HFM records 31A, the program loop 33 will “call” a particular polling API in the polling API store 22 that is specified in the linked list of HFM records 31A. As the result of executing the instructions in the polling API, a particular hardware register specified in the linked list of HFM records 31A is examined to determine whether or not certain hardware error bits are set. If the register error bits are set, then the polling API will return an error value that is stored in the hardware error store 32 for the period of time specified by the HFM record 40 currently being executed. Subsequent to the time that this error value is stored in the error store 32, the program loop 33 examines the stored error values associated with the most recently examined hardware register to determine whether the number of errors detected at the hardware register in question exceeds a threshold number. If so, then the HFM engine 21 can generate an alarm that can be sent to the GUI or used by the hardware to automatically perform some corrective action. Error values associated with particular hardware modules are stored in the error store 32 in the order of their occurrence and can be stamped with the network time in which they are stored in the store 32. The time of occurrence and the order of occurrence can be very helpful when performing a trouble shooting procedure to determine the cause of the failure.

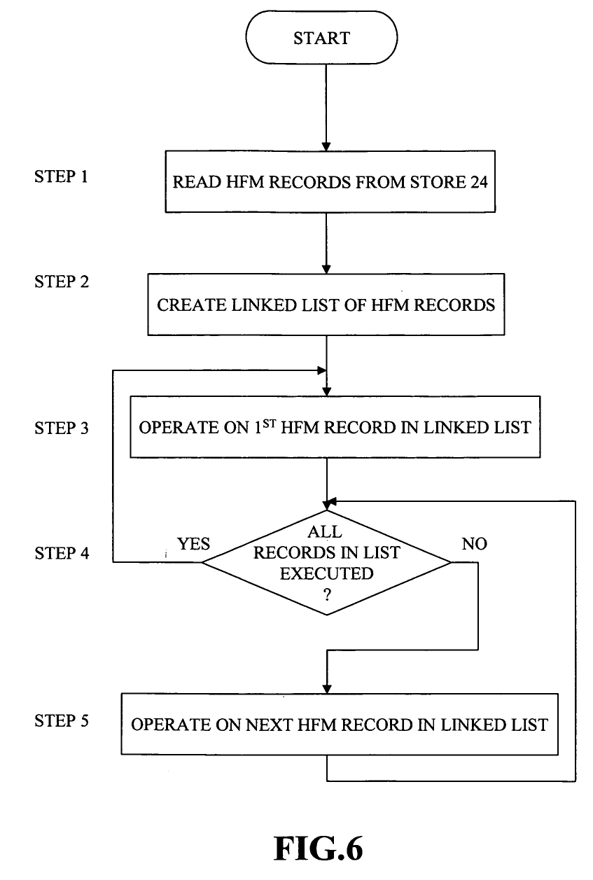

FIG. 6 is a high level logical flow diagram of the process of the invention. In step one of the process, the list generation module 31 of FIG. 5 reads all of the HFM records 25_{1-N} in the HFM record store 24 and in step 2 creates and stores in memory 2 of FIG. 1 a linked list of HFM records 31 a using only those HFM records that apply to, in this case, the line card 10. Each instance of a HFM engine 21 linked list generation module 31 is programmed to only load those HFM records 25_{1-N} that can be used by the HFM engine to, in this case, detect and diagnose failure on the line card 21. In step 3, the hardware health program loop 33 goes to the first or the next HFM record, which for the purposes of this description can be HFM record “4”, and proceeds to operate on the information and instructions contained in the record. At the point in the process that the program loop 33 completes operating on the record “4” it determines, in step 4, whether or not there are more HFM records in the linked list 31a to be operated on, and if not the process returns to step 3 and proceeds to again operate on the information and instruction contained in HFM record “4”. On the other hand if the process identifies another HFM record, which in this case can be HFM record “38”, in the linked list 31a, in step 5 it proceeds to operate on the information and instructions contained in this record. At the point that the process being executed by the program loop 33 completes operating on HFM record “38”, the process returns to step 4 and determines whether or not all of the HFM records in the linked list 31a have been operated on and if so, then the process returns to step 3 and the program loop continues.

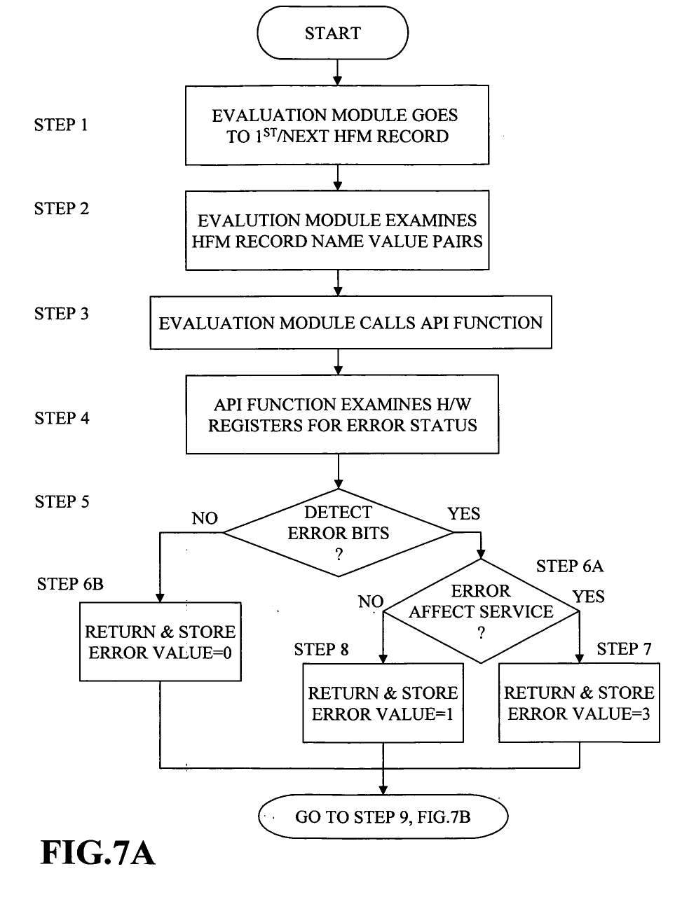

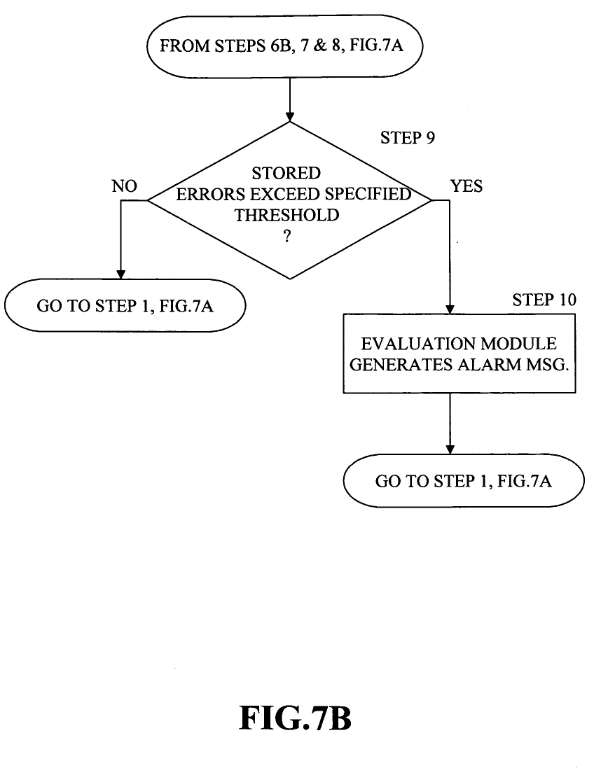

FIGS. 7a and 7b are a diagram illustrating detail of the logical flow employed by the program loop 33 to perform either step 3 or step 5 of FIG. 6. In step 1 of FIG. 7a, the program loop 33 upon boot up goes to the first HFM record, which in this case is record “4” in FIG. 4b, in the linked list 31a of FIG. 5, and in step 2 the program loop 33 starts to operate on the coded instructions or name value pairs of which the HFM record “4” is comprised. In step 3, the program loop 33 calls the API function specified by HFM record “4”, which in this case is “sddHfmPoll_{—}1_EnetCntlTXOVRSZ”, and the function, in step 4, proceeds to examine the “TXOVRSZ” hardware register located on the line card 10 to determine if any error bits are set. If, in step 5, it is determined that error bits are set in this register, the API function, in step 6a determines whether the error is service affecting or not. If the error is service affecting then in step 7 the API function returns an error value of “3” and if the error is non service affecting, in step 8 the API function returns an error value of “1”. On the other hand if, in step 5, no error bits are detected in the register then the API function, in step 6b, returns an error value of “0”. The three error values mentioned above are described earlier with reference to FIG. 2. Regardless of the error value that is returned by the API function, in step 9 the returned program loop module 33 examines the location in the hardware error store 32 in which the Ethernet controller 3 “TX oversize error values” are stored to determine whether the error(s) stored here exceed a specified threshold during an integration period. If the errors exceed the specified threshold, then in step 10 the Hfm engine 21 generates an alarm message and can send this message to the GUI 26 of FIG. 2 where it can be observed by a engineers for the diagnostic purposes. At this point the program loop 33 returns to step 1. On the other hand, if in step 9 the Hfm engine 21 determines that the error threshold has not been reached, then the program loop 33 returns to step 1.

We claim:

1. A method for evaluating the health of an electronic hardware module comprising:
creating a plurality of fault records;
linking two or more of the plurality of fault records together to create a linked list of fault records;
continuously executing the linked list of fault records to detect at least one hardware error in the electronic hardware module and storing an indication of the at least one detected hardware module error; and
using the stored indication of the at least one hardware module error to evaluate the health of the electronic hardware module.

2. The method of claim 1 further comprising using the evaluated health of the electronic hardware module to generate a hardware health message.

3. The method of claim 2 wherein the hardware health message is an alarm message.

4. The method of claim 1 wherein the stored indication of the at least one detected hardware module error is an error value.

5. The method of claim 3 wherein the alarm message is generated if the number of stored error values exceeds a specified quantity during one integration period.

6. The method of claim 1 wherein each of the fault records are comprised of a plurality of specified name value pairs.

7. The method of claim 6 wherein one or more of the plural specified name value pairs are modified during the hardware module operation.

8. The method of claim 4 wherein the indication of the at least one detected hardware module error is stored for a specified period of time.

9. The method of claim 1 wherein the linked list is continually executed by a hardware health evaluation function.

10. The method of claim 2 wherein the alarm message is used for one or both of a diagnostic procedure and an automatic hardware correction function.

11. Apparatus for evaluating the health of an electronic hardware module comprising:
A processor in communication with the electronic hardware module;
A memory coupled to the processor, the memory including:
an HFM record store that includes two or more hardware fault records; and
a hardware health evaluation module that operates to create a linked list composed of the two or more hardware fault records, to continuously execute the linked list of fault records to detect at least one hardware error in the electronic hardware module, to store an indication of the at least one detected hardware error and to use the stored indication of the at least one hardware module error to evaluate the health of the electronic hardware module.

12. The memory of claim 11 wherein the hardware health evaluation module uses the evaluated health of the electronic hardware module to generate a hardware health message.

13. The hardware health message of claim 12 is an alarm message.

14. The memory of claim 11 wherein the indication of the at least one detected hardware module error stored by the health evaluation module is an error value.

15. The memory of claim 11 wherein each of the two or more fault records in the HFM record store are comprised of a plurality of specified name value pairs.

16. The plural specified name value pairs comprising the two or more fault records in the HFM record store of claim 11 are modified during the hardware module operation.

17. The memory of claim 11 wherein the indication of the at least one detected hardware module error is stored for a specified period of time.
